(19) United States
(12) Patent Application Publication
(10) Pub. No.: US 2005/0086153 A1
(43) Pub. Date: Apr. 21, 2005

(54) Commodity stocks: a process for linking common stock directly to the value of physical commodities (e.g., gold, oil, wheat, hog bellies, currencies, etc.)

(76) Inventor: Aaron Edward Scott, Macclenny, FL (US)

Correspondence Address: AARON SCOTT, 141 Rhoden Dr., Macclenny, FL, 32063, US

(21) Appl. No.: 10/946,602

(22) Filed: Sep. 21, 2004

Related U.S. Application Data
(60) Provisional application No. 60/505,633, filed on Sep. 24, 2003.

(51) Int. Cl. G06F 17/60

(52) U.S. Cl. 705/37

(57) ABSTRACT

This invention comprises a process for finally bridging the divide between stock markets and commodity markets. This is accomplished by linking the price of a stock directly and solely to the spot price of a specific commodity (e.g., gold, oil, soybeans, etc.). This not only permits the buying/selling of much smaller units than the commodity market offers, but eliminates the expiration feature of futures contracts, permitting buyers/sellers to maintain positions for indefinite periods of time. Price linkage can be assured by basing the stock either on an actual reserve of the associated commodity or through other means (e.g., instant price adjustment to reflect real-time quotes of the spot price, etc.) that ensures appropriate price tracking. Shares may be exchanged for either equivalent units of the associated commodity, for the actual dollar value of the shares, for some combination thereof, or for any other suitable and equivalent value.

### CROSS REFERENCE TO RELATED APPLICATIONS

This application is based on provisional application serial number 60-505,633, filed on Sep. 24, 2003.

### STATEMENT REGARDING FEDERALLY SPONSORED RESEARCH OR DEVELOPMENT

Not Applicable

### Description of Attached Appendix

Not Applicable

### BACKGROUND OF THE INVENTION

This invention relates generally to the field of finance/financial instruments, and more specifically to a process for linking common stock directly to physical commodities (e.g., gold, oil, wheat, hog bellies, currencies, etc.).

In the early 1990's, when I first began to educate myself about financial markets, it seemed to me that it would be better for all involved if commodities were structured like commodities. Surely it would be much more appealing if there were stocks that, like futures contracts, were based on an underlying commodity, but unlike futures contracts, did not have an expiration date. This would permit investors/speculators to hold onto a commodity position indefinitely, long after a futures contract had expired. Moreover, traders would not have to worry about their stock becoming worthless, since commodities, theoretically, will always be worth at least their intrinsic value (i.e., a troy ounce of gold will always have some worth, thereby ensuring that any stock linked to directly to the value of gold would also be of value).

At the time, however, in my attempt to link stocks and commodities, I initially linked the stock to what seemed to be its obvious equivalent in the commodities market: futures contracts. But by doing so, I found that now my conceptual stock would be negatively impacted by the expiration date of the associated futures contract. Very simply, the expiration of a futures contract and its subsequent replacement by the next scheduled futures contract (which would typically be priced higher) would tend to create a significant price spike in any stock based on the futures contract price. Thus, the expiration and subsequent replacement of a futures contract would require that I either find some way of smoothing the stock price during the transfer from one futures contract to the next, or else that I create a separate issue of stock for each contract month which would cause the stock itself to expire with the associated futures contract, thereby causing the stock to become, for all practical purposes, the same as a futures contract.

And so, not finding a solution at the time, I turned my attentions elsewhere. Every so often, I would revisit this matter of seeking to bridge the divide between stocks and commodities, but to little effect.

I successfully traded during the bull market years of the mid- and late 1990's. But then, during the economic downturn of 2000-2001, I gave back most, if not all, of my gains from the 1990's. Compounding this was the fact that I had been entrusted with my father's modest IRA.

In the mid-1990's, I had learned that my fifty-seven-year-old father, the pastor of a small church and quickly approaching retirement age, had only around $36,000 in his IRA. Having experienced some success in the tremendous stock market move of that time period, I asked for the opportunity to try to do more for his account than the 6% that his annuity was paying. He agreed, and over the next five or so years, I took his account from around $36,000 to over $160,000 (and my accounts, though smaller, showed similar growth). Thus, when the stock market turned, taking my fathers account back to almost what it was at the beginning, I questioned my financial aptitude and despaired of ever trading again. Eventually, though, I began to take account of the situation, seeking to determine if there was some angle of the investment world where I would have a natural edge. This was the first step toward my invention . . .

Since I had been so negatively affected by the economic downturn, I began to wonder if there was a way to protect myself against just such situations. Specifically, I wondered if there was a way to hone my stock selection skills, ensuring that I purchased only those stocks that would be winners. But in any case, I knew that I simply did not have the patience nor the skill to involve myself in all the complex formulas and moving averages that seemed to be a part of the successful trader's repertoire. So I wondered if there were perhaps any winning stocks that I could just intuitively select. And that is when my invention began to evolve.

Having long been a movie lover, and confident that I had some skill in divining which movies would go on to become box office winners, etc., I thought it would be most convenient if I could invest in specific movies. Such a stock would permit investors/speculators to base their investment decisions on their perceptions of specific movies rather than on the overall performance of some broadly-diversified parent company (i.e., investing in a specific blockbuster like “Lord of the Rings,” rather than in the broadly-diversified parent company, Time Warner).

This seemed to be a good idea, and over time I expanded this concept to include not only stock in particular movies, but in particular sports teams, specific professional athletes, rock stars, NASCAR drivers/teams, and so forth. But then I began to consider that, regardless of how exciting such stocks might be, they were still just that: stocks. And since my painful lesson in trading had demonstrated that I was less than capable of predicting the future of stocks, I still had little guarantee of my success. After all, I was not infallible when it came to movies. And the bad behavior of a sports star could send the associated stock tumbling. So I was still left to ponder how to find a virtually foolproof way to make money in the stock market.

At some point, I realized that stock exchanges make money in good times and bad, since, to my knowledge, they make money from the listing of the stock, as well as an exchange fee for every trade that takes place. Thus, regardless of the direction of the market, the exchange could make money. But there were already plenty of stock exchanges. I would have to find some way of differentiating my exchange from the others. And so I combined my stock concept and my stock exchange idea. Thus, my thinking now evolved into having a stock exchange that would attract business by being the exclusive exchange for a new, exciting stock that was based on specific movies, sports teams, etc.

Soon thereafter, however, I conceded that such stocks (based on specific movies, etc.) might be considered more of a novelty than anything else, and thus might not be very successful. I needed a stock that would be taken very seriously by the financial world-especially if I was to generate enough volume on this stock exchange to make it a lucrative venture. Then, an old puzzle from the past came to mind . . . a puzzle involving how to combine stocks and commodities. And so, starting at the beginning, I began again to ponder the issues surrounding this matter. But yet again, I ran into the same problems that had before brought me to a halt.

I knew that if a stock trader wished to invest directly in oil, he would be largely limited to broadly diversified companies such as Exxon (much like the problem encountered by those who might wish to invest only in a specific movie). Thus, a stock trader could not invest directly in (the commodity of) oil, but only in companies that were in some way associated with oil. And so, it was quite possible for the price of oil to increase (or decrease), but for the stock price to not reflect that price change at all (perhaps just the opposite), due to a company's earnings reports, expenditures, management changes, liabilities, etc.

A commodities trader, on the other hand, could invest directly in oil. When the price of oil went up, so did the value of his position. However, the commodities trader was limited by the expiration feature of futures contracts, meaning that if he was to profit, he must by all means do so prior to the expiration date of the futures contract.

It occurred to me that by combining the benefits of stocks (i.e., the ability to hold onto the stock indefinitely) with the capabilities of commodities (i.e., the ability to invest directly in a commodity, rather than just in a company that was in some way associated with the commodity), one could arrive at a stock that permitted one to invest/speculate in commodities without concern for the expiration date. And so, as before, I arrived at a stock that was linked to the price of a particular commodity.

However, also as before, configuring such a linkage proved problematic. For when a futures contract expired, the contract that then replaced it was typically priced significantly higher (due to the premium that the buyer pays for the additional time remaining before this new contract expires, etc.). Thus, if the stock were tracking the current futures contract, then on the contract's expiration day, the stock would close at the expiring contract's value. But the very next business day, the expired futures contract having been replaced by the subsequent—and now current—futures contract, the stock would open at the new contract's (typically) higher price. This almost-guaranteed price jump every month could potentially create havoc on the stock market I envisioned, for 1 imagined that few would sell their shares when, by holding for another day, they could sell for even more. Yet many, hoping to make a quick profit on the pending price jump, would probably clamor for shares on expiration day, perhaps creating price pressure that would take the stock out of alignment with the futures contract price. This and other considerations forced me to acknowledge that too much “gaming” of the system could be done if stocks were linked to futures contracts, all to the eventual detriment of my envisioned stock exchange.

Finally, however, after finding no acceptable manner in which to link stocks and futures contracts, and after much intensive thought and research, I came upon an elegant solution: Instead of linking the stock price to the futures contract price, instead link the stock price directly to the spot price of the commodity. (The spot price is basically the price one would pay for immediate delivery of the commodity. It does not include any premium for time before expiration, carrying costs, etc. It is the intrinsic value of the commodity at that particular point in time.) And that, for all its simplicity, was the solution to the stock/commodity issue. I had finally bridged the divide between stocks and commodities. Stocks would now be able to be directly linked to the value of a specific commodity. Traders would be able to take positions in commodities and be assured that their stock would never become worthless. Traders would be able to invest/speculate in the fortunes of a commodity without being concerned with contract expiration dates. Smaller traders would be able to buy as little as a single share, thus enabling them to engage in commodities investmen/speculation that might have been too expensive for them before. Furthermore, in all of my research, I could find not a single mention of such a linkage as I envisioned. The originality of this idea was further supported by the fact that such a linkage had never taken place on stock or commodity exchanges, even though such a linkage had been theoretically possible for more than two decades.

This exciting and original stock, especially when coupled with the stock exchange that I had envisioned, seemed to have tremendous potential. But in 2001, not knowing how to take my idea to the next level, I began seeking expert advice. I sent e-mails to a very small group of individuals that I deemed to be financial leaders (e.g., a world-famous trader, an exchange official, a gold bullion dealer, etc.). Though some were kind enough to offer brief feedback, none indicated that my invention was of any particular interest or worth.

In August of 2001, 1 sent an e-mail to Mr. Peter Daniels, a gold bullion dealer in Australia. I asked him for confidentiality and described stocks based on the spot price of commodities, as well as the new stock exchange on which these stocks would trade. I never received a reply, and so assumed that he was not interested in my invention. And so, at some point, not having received any encouragement from those with greater expertise, I came to an impasse that caused me to place my pursuit on hold.

Then, in the spring of 2003, eighteen months after my e-mail to the Australian continent, there appeared on the Australian Stock Exchange a new stock. A stock that was based on . . . the spot price of gold! While I certainly felt vindication for my ideas (my invention had proven valid and valuable, after all), I was also quite taken aback, for 1 had conducted extensive research during the creation of my invention and had not found a single word about such a stock as I envisioned. And having discerned that my invention was potentially very valuable, I had been extraordinarily discreet. Thus, I felt it very likely that the Australian stock had originated with my e-mail to Mr. Daniels. (Incidentally, I do not attribute any wrongdoing to Mr. Daniels; I can only assume that someway, somehow, my e-mailed idea leaked and rippled outwards until it eventually found the ears of someone who, perhaps with no ill intent, took advantage of it.) After determining that I apparently had no legal grounds on which to proceed against those in Australia who had, I was sure, used my idea, (attorneys advised me that my e-mail request for confidentiality carried no weight unless the other party had agreed to abide by my request), I turned my attentions to protecting my idea in the United States.

I now realized that my grand plan of having an exclusive stock exchange on which to trade my new stock was just no longer feasible—after all, a stock based on the spot price of a commodity was now trading on the Australian Stock Exchange. However, as was apparent from the strong success of the Australian gold stock, the other aspect of my plan (i.e., stocks based on the spot price of commodities) was very much feasible. I was confident that it would eventually spread to other major stock exchanges. And so, in an effort to seek protection for my invention, I took out a Provisional Patent Application on Sep. 24, 2003, and am now following it up with a Non-Provisional Patent Application.

The greatest deficiency in the prior technology is that there seems to have been no sustained effort (at least not a successful one) to combine the benefits of stocks and commodities into a financial instrument that would invite investors/speculators from both markets, would decrease risk to the stock holder (by eliminating the possibility of the stock becoming worthless), and so forth. Prior to my efforts in this area, I could find no indication of there being any reports, discussions, essays, articles, etc., regarding finding a way to link stocks directly to commodities. And certainly I could find no discussion of the solution at which I eventually arrived.

Upon delving into this matter, I found that the most apparent theoretical problem arose when seeking to link stock prices to futures contracts. It was determined that this arrangement would allow too much gaming of the system. Quite simply, on the day that a futures contract expires, the contract that replaces it is typically priced higher than the expiring contract (i.e., a premium is charged for the additional time before expiration, etc.). This price difference would permit speculators to simply buy the stock just before the current contract expiration date, then sell it for a profit on the day the subsequent (and more valuable) contract became the current contract. This would very likely dry up liquidity, since there might be no stockholders willing to sell their stock a day prior to an almost guaranteed rise in price. Or, on the other hand, demand for the guaranteed profit could possibly drive the stock price out of close alignment with the commodity price.

I sought to find some “smoothing” mechanism that would keep the stock price from such fluctuations, but found all my formulations inadequate due to the complexity and confusion that traders would encounter. This and other issues made the linking of stocks and futures contracts largely impossible.

Further, a single futures contract usually represents a substantial amount of the corresponding commodity. For instance, a single futures contract for heating oil may represent 42,000 gallons of the commodity, or a single contract of gold may represent 100 troy ounces, etc. While these sizes probably better serve the purposes of large producers and manufacturers, they can exclude many smaller traders that cannot afford either the risk or the cost of such substantial positions.

### BRIEF SUMMARY OF THE INVENTION

The primary object of the invention is to merge the benefits of stocks and commodities, permitting stock investors/speculators to conduct trading based directly upon an actual commodity.

Another object of the invention is to permit broader ownership/involvement (especially by the smaller trader) by permitting the trading of smaller units of value than traditional futures contracts typically permit.

In accordance with a preferred embodiment of the invention, there is disclosed a process for linking common stock directly to the value of physical commodities (i.e., items such as gold, oil, wheat, hog bellies, currencies, lumber, soybeans, etc., that typically trade on commodity exchanges). This process is comprised (but not limited to) the steps of: linking/associating each applicable stock directly and solely to the spot price of a specific commodity and ensuring that the stock will closely track the spot price of the associated commodity by means of
basing the stock price on the value of an actual reserve of the specific commodity, or
linking the stock to the real-time spot price (or other suitable posted price) of the associated commodity (since either scenario can conceivably provide near perfect tracking of the price of the associated commodity), or
linking the stock and commodity values by any other means that offer similar results.

This process further comprises permitting the stock to be exchanged for:
receipt of literalunits of the actual corresponding commodity, or
the actual dollar value of the stock, or
any combination thereof, or
any applicable units of value deemed suitable.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for linking common stock directly to the value of physical commodities (i.e., items such as gold, oil, wheat, hog bellies, currencies, lumber, soybeans, etc., that typically trade on commodity exchanges), comprising the steps of:
Linking/associating each said stock directly and solely to the spot price of a specific commodity;
Ensuring that said stock will closely track the spot price of the associated commodity by means of either linking the stock price to the value of an actual reserve of the specific commodity; linking the stock to the real-time spot price (or other suitable posted price) of the specific associated commodity (since either scenario can conceivably provide near perfect tracking of the price of the associated commodity); or linking the stock and commodity values by any other means that offer similar results; and
Permitting the stock to be exchanged for receipt of literal units of the actual corresponding commodity, for the actual dollar value of the stock, for any combination thereof, or for any applicable units of value deemed suitable.
